(19) United States
(12) Patent Application Publication
(10) Pub. No.: US 2025/0062842 A1
(43) Pub. Date: Feb. 20, 2025

(54) WIRELESS COMMUNICATION DEVICE FOR DETECTING INTERFERENCE AND OPERATING METHOD OF THE SAME

(71) Applicant: Samsung Electronics Co., Ltd., Suwon-si (KR)

(72) Inventors: Eunhye Park, Suwon-si (KR); Jinmin Kim, Suwon-si (KR); Jungwoon Lee, Suwon-si (KR); Sukjin Jung, Suwon-si (KR)

(21) Appl. No.: 18/804,134

(22) Filed: Aug. 14, 2024

(30) Foreign Application Priority Data
Aug. 17, 2023 (KR) 10-2023-0107934
Nov. 20, 2023 (KR) 10-2023-0160303

(51) Int. Cl. H04B 17/309; H04L 5/00; H04L 25/02

(52) U.S. Cl. CPC H04B 17/346; H04L 5/0051; H04L 25/0222

(57) ABSTRACT

An operating method of a wireless communication device includes: receiving a reference signal transmitted from a second wireless device; calculating a reference noise value based on the reference signal; calculating, by the processor, a noise threshold value based on the reference noise value; receiving a first data signal transmitted from the second wireless device; calculating a data noise value based on the first data signal; comparing, by the processor, the data noise value with the noise threshold value; determining whether interference occurs in a target symbol based on a result of the comparison; adjusting the noise threshold value based on the data noise value when it is determined that the interference has occurred in the target symbol; and receiving a second data signal transmitted from the second wireless device, and using the adjusted noise threshold value in processing the second data signal.

### CROSS-REFERENCE TO RELATED APPLICATIONS

This application is based on and claims priority under 35 U.S.C. § 119 to Korean Patent Application Nos. 10-2023-0107934, filed on Aug. 17, 2023 and 10-2023-0160303, filed on Nov. 20, 2023, in the Korean Intellectual Property Office, the disclosures of which are incorporated by reference herein in their entirety.

### BACKGROUND

Aspects of the inventive concept relate to a wireless communication device that detects interference.

A wireless communication system may include a plurality of wireless communication devices. Each of the wireless communication devices may communicate with other wireless communication devices using a method, such as wireless fidelity (Wi-Fi) or Bluetooth.

Because many signals are transmitted between wireless communication devices when the wireless communication devices communicate with each other, interference may occur in a signal. The interference occurring in the signal causes an error in data included in the signal and may thus cause an error in data transmission between the wireless communication devices. Therefore, in order to cope with such interference, it is desired to develop a method of accurately detecting interference.

### SUMMARY

Aspects of the inventive concept provide a wireless communication device capable of accurately detecting interference occurring in a data signal.

According to an example embodiment, an operating method of a wireless communication device includes: receiving at a receiver of a first wireless device a reference signal transmitted from a second wireless device; calculating, by a processor of the first wireless device, a reference noise value based on the reference signal; calculating, by the processor, a noise threshold value based on the reference noise value; receiving at the receiver of the first wireless device a first data signal transmitted from the second wireless device; calculating, by the processor, a data noise value based on the first data signal; comparing, by the processor, the data noise value with the noise threshold value; determining, by the processor, whether interference occurs in a target symbol based on a result of the comparison; adjusting, by the processor, the noise threshold value based on the data noise value when it is determined that the interference has occurred in the target symbol; and receiving at the receiver of the first wireless device a second data signal transmitted from the second wireless device, and using the adjusted noise threshold value in processing the second data signal.

According to an example embodiment, an operating method of a wireless communication device includes: receiving at a receiver of a first wireless device a reference signal transmitted from a second wireless device; calculating, by a processor of the first wireless device, a reference noise value and a reference received value based on the reference signal; calculating, by the processor, a noise threshold value and a reception threshold value respectively based on the reference noise value and the reference received value; receiving at the receiver of the first wireless device a first data signal transmitted from the second wireless device, the first data signal including a first type block and a second type block; calculating, by the processor, a data noise value and a data received value based on the first data signal; based on whether interference occurs in a previous symbol before a target symbol, either comparing, by the processor, the data noise value with the noise threshold value, or comparing, by the processor, the data received value with the reception threshold value; determining, by the processor, whether interference occurs in the target symbol based on a result of the comparison; adjusting, by the processor, the noise threshold value and the reception threshold value respectively based on the data noise value and the data received value when it is determined that the interference has occurred in the target symbol; and receiving at the receiver of the first wireless device a second data signal transmitted from the second wireless device, and using the adjusted noise threshold value and reception threshold value in processing the second data signal.

According to an example embodiment, a wireless communication device includes a transceiver configured to receive a reference signal, and a first data signal, and a second data signal, from an external device; and a processor configured to calculate a reference noise value based on the received reference signal, calculate a noise threshold value based on the reference noise value, calculate a data noise value based on the received first data signal, compare the data noise value with the noise threshold value, determine whether interference occurs in a target symbol based on a result of the comparison, and adjust the noise threshold value based on the data noise value when it is determined that the interference has occurred in the target symbol, and use the adjusted noise threshold value for processing the received second data signal . . .

### BRIEF DESCRIPTION OF THE DRAWINGS

Embodiments will be more clearly understood from the following detailed description taken in conjunction with the accompanying drawings in which:

FIG. 1 is a diagram of a wireless communication system according to an embodiment;

FIG. 2 is a block diagram of a wireless communication device according to an embodiment;

FIG. 3 is a flowchart of an operating method of a wireless communication device, according to an embodiment;

FIG. 4 is a flowchart of subsequent operations that may be performed when interference occurs in a target symbol in an operating method of a wireless communication device, according to an embodiment;

FIG. 5 illustrates an example of a reference signal and a data signal, which are received by a wireless communication device, according to an embodiment;

FIG. 6 is a flowchart of an operating method of a wireless communication device, according to some embodiments;

FIG. 7 is a detailed flowchart of operation S660 in FIG. 6;

FIG. 8 is a flowchart of operations that may be performed when interference is not detected in an operating method of a wireless communication device, according to an embodiment; and

FIG. 9 is a schematic block diagram of an electronic device according to an embodiment.

### DETAILED DESCRIPTION OF THE EMBODIMENTS

Hereinafter, embodiments are described in detail with reference to the accompanying drawings.

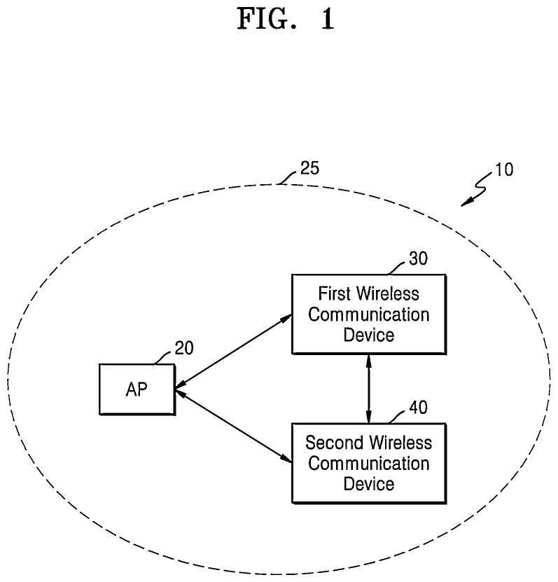

FIG. 1 is a diagram of a wireless communication system according to an embodiment.

Referring to FIG. 1, a wireless communication system 10 may include an access point (AP) 20, a first wireless communication device 30, and a second wireless communication device 40.

In an embodiment, the wireless communication system 10 may perform short-range wireless communication using a method, such as wireless fidelity (Wi-Fi) or Bluetooth. However, embodiments are not limited thereto. The wireless communication system 10 may correspond to one of a new radio (NR) system, a 5th generation (5G) system, a long term evolution (LTE) system, a code division multiple access (CDMA) system, a global system for mobile communication (GSM), a wireless local area network (WLAN) system, and other wireless communication systems.

The AP 20 may provide wireless access to a network to allow the first and second wireless communication devices 30 and 40 in a coverage area 25 to use communication services. In an embodiment, the AP 20 may communicate with the first and second wireless communication devices 30 and 40 by using Wi-Fi or other WLAN communication technology.

The first and second wireless communication devices 30 and 40 may be stationary or mobile. Each of the first and second wireless communication devices 30 and 40 may refer to a device that may exchange data and/or control information with the AP 20 through communication. For example, each of the first and second wireless communication devices 30 and 40 may be referred to as a terminal, terminal equipment, a mobile station (MS), a mobile terminal (MT), a user terminal (UT), a subscribe station (SS), a wireless device, a handheld device, or the like.

In an embodiment, the first wireless communication device 30 may communicate with the second wireless communication device 40 by using Bluetooth or other short-range communication technology.

When the first wireless communication device 30 receives a signal from the second wireless communication device 40 in the wireless communication system 10, interference may occur in the signal, which the first wireless communication device 30 receives from the second wireless communication device 40, because of a signal transmitted during the communication between the AP 20 and the second wireless communication device 40. As described above, when communications among various devices are simultaneously performed, the probability of interference occurring in a signal from one of the devices may rapidly increase. Interference occurring in a signal may cause an error in data included in the signal, and therefore, a method of accurately detecting interference is needed.

In an embodiment, each of the first and second wireless communication devices 30 and 40 may receive a reference signal, calculate a reference noise value based on the reference signal, calculate a noise threshold value based on the reference noise value, receive a data signal, calculate a data noise value based on the data signal, compare the data noise value with the noise threshold value, and determine whether interference occurs in a target symbol. When it is determined that interference has occurred in the target symbol, each of the first and second wireless communication devices 30 and 40 may adjust the noise threshold value based on the data noise value. As described above, according to an embodiment, when it is determined that interference has occurred in the target symbol, each of the first and second wireless communication devices 30 and 40 may increase the interference detection performance thereof by adjusting the noise threshold value that is used for subsequent interference detection.

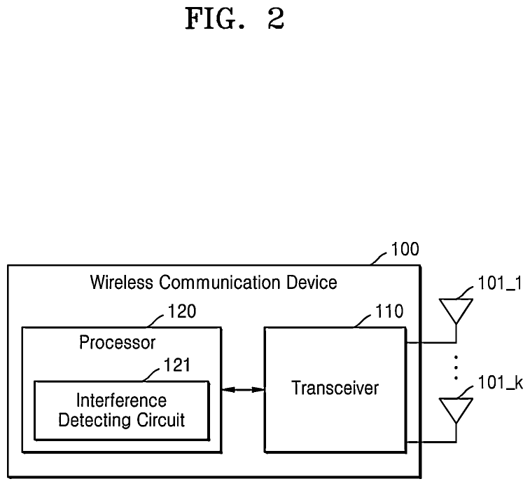

The detailed structure and operating method of the first and second wireless communication devices 30 and 40 are further described with reference to FIG. 2 below.

FIG. 2 is a block diagram of a wireless communication device according to an embodiment.

Referring to FIG. 2, according to an embodiment, a wireless communication device 100 may include a plurality of antennas 101_1 to 101_k, a transceiver 110, and a processor 120. The wireless communication device 100 of FIG. 2 may correspond to one of the first and second wireless communication devices 30 and 40 in FIG. 1.

The transceiver 110 may receive a reference signal and a data signal from an external device (e.g., another wireless communication device) through the antennas 101_1 to 101_k. The transceiver 110 may generate intermediate-frequency or baseband signals by performing frequency down-conversion of the reference signal and the data signal. The transceiver 110 may also perform frequency up-conversion of intermediate-frequency or baseband signals output from the processor 120 and output a reference signal and a data signal through the antennas 101_1 to 101_k.

The processor 120 may generally control communication operations of the wireless communication device 100. The processor 120 may be implemented by using an application processor, a central processing unit (CPU), a numeric processing unit (NPU), a graphics processing unit (GPU), and/or the like.

The processor 120 may obtain data by performing filtering, decoding, and digitization of intermediate-frequency or baseband signals. The processor 120 may perform a certain operation based on the obtained data. The processor 120 may encode, multiplex, and convert into analog the data generated through the certain operation.

The processor 120 may include an interference detecting circuit 121. The interference detecting circuit 121 may perform interference detection, according to embodiments. The operations of the interference detecting circuit 121, which are described below, may be considered as the operations of the processor 120. Specifically, the interference detecting circuit 121 may be implemented by hardware and/or may be stored in a memory (not shown) as program code that is executed by the processor 120 to perform channel estimation according to embodiments.

In an embodiment, the interference detecting circuit 121 may calculate a reference noise value based on a reference signal received through the transceiver 110. Here, the reference signal may refer to a signal that has been agreed in advance (e.g., predetermined in advance) and is transmitted for an operation, such as initial access setting, when wireless communication with an external device is performed. The reference noise value may be calculated based on noise included in the reference signal.

In detail, the interference detecting circuit 121 may calculate noise with respect to each of a first number of symbols that are preset in a reference signal. The first number may be less than or equal to the number of all symbols included in the reference signal.

Thereafter, the interference detecting circuit 121 may calculate a reference noise value based on the noise with respect to each symbol of the first number of symbols. For example, the interference detecting circuit 121 may calculate an error vector magnitude (EVM) value or an average power value as the reference noise value.

The interference detecting circuit 121 may calculate a reference noise value by calculating an EVM value based on noise with respect to each symbol of the first number of symbols by using Equation 1.

$$n P w {r}_{ref 1} = \frac{1}{\overline{D}} \sqrt{\frac{I}{{N}_{ref}} {\sum }_{i = 1}^{{N}_{ref}} {( {y}_{i} - \hat{h} {s}_{i} )}^{2}} \qquad [ Equation l ]$$

In Equation 1, nPwr_{ref1} represents an EVM value calculated based on noise in the first number of symbols included in the reference signal. N_{ref} represents the first number. In Equation 1, yᵢ represents a received value of an i-th symbol among the first number of symbols. A value received through the reference signal may be used as yᵢ. In Equation 1, \hat{ }h represents a channel estimation value and may be obtained by estimation through yᵢ. In Equation 1, sᵢ represents a reference value transmitted through the i-th symbol among the first number of symbols and may have a value that is agreed between the wireless communication device 100 and an external device. At this time, (yᵢ−ĥsᵢ) represents noise that is calculated with respect to the i-th symbol among the first number of symbols included in the reference signal. D̅ represents average power according to a method of modulating a plurality of symbols included in the reference signal and may have a value that is predefined according to a modulation method agreed between the wireless communication device 100 and the external device.

The interference detecting circuit 121 may also calculate a reference noise value by calculating an average power value based on the noise with respect to each symbol of the first number of symbols by using Equation 2.

$$n P w {r}_{ref 2} = \frac{1}{{N}_{ref}} {\sum }_{i = 1}^{{N}_{ref}} {( {y}_{i} - \hat{h} {s}_{i} )}^{2} \qquad [ Equation 2 ]$$

In Equation 2, nPwr_{ref2} represents an average power value calculated based on noise in the first number of symbols included in a reference signal and the other variables may be the same as those described above.

In addition, in an embodiment, the interference detecting circuit 121 may calculate a reference received value based on a reference signal received through the transceiver 110. The reference received value may be calculated based on the received reference signal.

In detail, the interference detecting circuit 121 may calculate a reference received value based on a received value of each symbol of the first number of symbols. For example, the interference detecting circuit 121 may calculate an average power value as a reference received value.

The interference detecting circuit 121 may calculate a reference received value by using Equation 3.

$$y P w {r}_{ref} = \frac{1}{{N}_{ref}} {\sum }_{i = 1}^{{N}_{ref}} {y}_{i}^{2} \qquad [ Equation 3 ]$$

In Equation 3, yPwr_{ref} represents an average power value calculated based on the received values of the first number of symbols included in a reference signal and the other variables may be the same as those described above.

In an embodiment, the interference detecting circuit 121 may calculate a noise threshold value based on a reference noise value. Here, the noise threshold value may refer to a reference value for detecting interference occurring in a data signal described below.

In detail, the interference detecting circuit 121 may set a noise coefficient based on an interference false alarm rate. The interference false alarm rate may refer to a rate at which the wireless communication device 100 detects interference even though there is no interference occurring in a data signal. When the interference false alarm rate is low, the probability of incorrectly detecting interference even though there is no interference may decrease while the probability of failing to detect interference that has occurred may increase. Contrarily, when the interference false alarm rate is high, the probability of incorrectly detecting interference even though there is no interference may increase while the probability of failing to detect interference that has occurred may decrease. Considering that the noise coefficient is in inverse proportion to the interference false alarm rate, a noise coefficient corresponding to an interference false alarm rate desired by a user may be set. For example, a look-up table (LUT) including a noise coefficient corresponding to an interference false alarm rate may be stored in the wireless communication device 100, and the interference detecting circuit 121 may set a noise coefficient, which corresponds to an interference false alarm rate desired by a user, based on the LUT.

Thereafter, the interference detecting circuit 121 may calculate a noise threshold value, based on the reference noise value and the noise coefficient. The interference detecting circuit 121 may calculate the noise threshold value by using Equation 4.

$${γ}_{n} = {α}_{n} \cdot {nPwr}_{ref} \qquad [ Equation 4 ]$$

In Equation 4, γₙ represents a noise threshold value, αₙ represents a noise coefficient, and nPwr_{ref} is a reference noise value.

In an embodiment, the interference detecting circuit 121 may calculate a reception threshold value based on a reference received value. Here, the reception threshold value may refer to a reference value for detecting interference occurring in a data signal.

In detail, the interference detecting circuit 121 may set a reception coefficient based on an interference false alarm rate. At this time, considering that the reception coefficient is in inverse proportion to the interference false alarm rate, a reception coefficient corresponding to an interference false alarm rate desired by a user may be set. For example, an LUT including a reception coefficient corresponding to an interference false alarm rate may be stored in the wireless communication device 100, and the interference detecting circuit 121 may set a reception coefficient, which corresponds to an interference false alarm rate desired by a user, based on the LUT.

Thereafter, the interference detecting circuit 121 may calculate a reception threshold value based on the reference received value and the reception coefficient. The interference detecting circuit 121 may calculate the reception threshold value by using Equation 5.

$${γ}_{y} = {α}_{y} \cdot {yPwr}_{ref} \qquad [ Equation 5 ]$$

In Equation 5, γ_{y} represents a reception threshold value, α_{y} represents a reception coefficient, and yPwr_{ref} is a reference received value.

In an embodiment, the interference detecting circuit 121 may calculate a data noise value based on a data signal, which is received by the transceiver 110. Here, the data signal refers to a signal that transfers data to be received by the wireless communication device 100 through wireless communication with an external device, and a data noise value may be calculated based on noise included in the data signal.

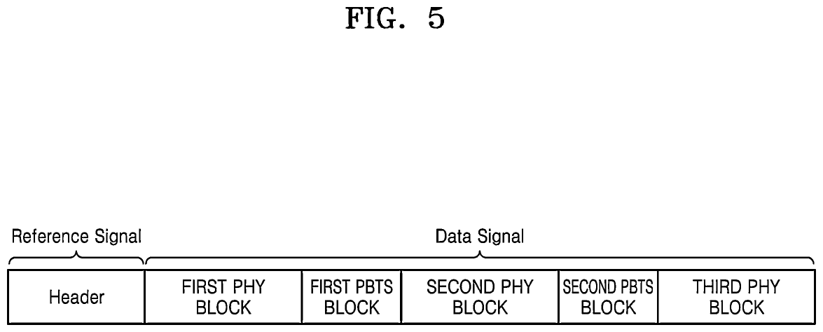

In an embodiment, a data signal may include a first type block and a second type block. The first type block may include data to be transmitted by an external device and the second type block may include a training sequence that is agreed between the external device and the wireless communication device 100. An example of the data signal is described with reference to FIG. 5 below.

In detail, the interference detecting circuit 121 may calculate noise with respect to each of a preset second number of symbols included in the data signal. At this time, the second number may refer to a number of symbols included in a data signal, which is used to determine occurrence or non-occurrence of interference, and may be set to allow a data noise value and a data received value to be significant.

Thereafter, the interference detecting circuit 121 may calculate a data noise value based on noise with respect to each symbol of the second number of symbols. For example, the interference detecting circuit 121 may calculate one of an EVM value and an average power value as the data noise value.

The interference detecting circuit 121 may calculate a data noise value by calculating an EVM value based on noise with respect to each symbol of the second number of symbols by using Equation 6.

$$n P w {r}_{sum 1} = \frac{1}{\overline{D}} \sqrt{\frac{1}{N} {\sum }_{i = 1}^{N} {( {y}_{i} - \hat{h} {\hat{s}}_{i , dec} )}^{2}} \qquad [ Equation 6 ]$$

In Equation 6, nPwrₛᵤₘ₁ represents an EVM value calculated based on noise in the second number of symbols included in the data signal. N represents the second number. ŝ_{i,dec} represents an estimated value obtained by decoding a data value transmitted through an i-th symbol among the second number of symbols. (yᵢ−ĥŝ_{i,dec}) represents noise that is calculated with respect to the i-th symbol among the second number of symbols included in the data signal, and the other variables may be the same as those described above.

The interference detecting circuit 121 may also calculate a data noise value by calculating an average power value based on the noise with respect to each symbol of the second number of symbols by using Equation 7.

$$n P w {r}_{sum 2} = \frac{1}{N} {\sum }_{i = 1}^{N} {( {y}_{i} - \hat{h} {\hat{s}}_{i , dec} )}^{2} \qquad [ Equation 7 ]$$

In Equation 7, nPwrₛᵤₘ₂ represents an average power value calculated based on noise in the second number of symbols included in a data signal and the other variables may be the same as those described above.

In an embodiment, the second number of symbols may be included in the first type block. For example, the interference detecting circuit 121 may calculate a data noise value by using a group of symbols included in the first type block among symbols included in a data signal. Stated another way, the interference detecting circuit 121 may calculate a data noise value by using a group of symbols having a first type, which group of symbols are included in a first block type, which includes the first type of symbols. An example of a block type is a PHY block or a PBTS block, as can be seen in FIG. 5, discussed in greater detail below.

In detail, when the interference detecting circuit 121 calculates a data noise value by using the second number of symbols included in a data signal, the interference detecting circuit 121 may use the second number of symbols included in the first type block. For example, the interference detecting circuit 121 may use a group of symbols having a first type, which group of symbols are included in a first block type. When the second number of symbols includes symbols that are included in the second type block (e.g., when the second number of symbols is a group of symbols having the second type and being part of a second block type), the interference detecting circuit 121 may exclude the symbols included in the second type block from the second number of symbols and use symbols included in the first type block among subsequent symbols in the data signal.

For example, when “k” symbols among N symbols to be used to calculate a data noise value are included in the second type block (where “k” is a natural number that is at least 1 and less than or equal to N), the interference detecting circuit 121 may calculate the data noise value by using “k” symbols included in the first type block among symbols following the N symbols.

However, embodiments are not limited thereto. The interference detecting circuit 121 may calculate a data noise value by using both symbols included in the first type block and symbols included in the second type block among the symbols of a data signal.

In an embodiment, the interference detecting circuit 121 calculates a data received value based on a data signal received by the transceiver 110. The data received value may be calculated based on the received data signal.

In detail, the interference detecting circuit 121 may calculate a data received value based on the received value of each of the second number of symbols. For example, the interference detecting circuit 121 may calculate an average power value as the data received value.

The interference detecting circuit 121 may calculate a data received value by using Equation 8.

$$y P w {r}_{sum} = \frac{1}{N} {\sum }_{i = 1}^{N} {y}_{i}^{2} \qquad [ Equation 8 ]$$

In Equation 8, yPwrₛᵤₘ may represent an average power value calculated based on the received values of the second number of symbols included in a data signal and the other variables may be the same as those described above.

In an embodiment, the interference detecting circuit 121 may calculate a data received value by using symbols included in the first type block among symbols included in a data signal. When the interference detecting circuit 121 calculates a data received value by using the second number of symbols included in a data signal, the interference detecting circuit 121 may use the second number of symbols included in the first type block.

However, embodiments are not limited thereto. The interference detecting circuit 121 may calculate a data received value by using both symbols included in the first type block and symbols included in the second type block among the symbols of a data signal.

In an embodiment, the interference detecting circuit 121 may compare a data noise value with a noise threshold value. The interference detecting circuit 121 may determine whether interference occurs in a target symbol based on a result of comparing the data noise value with the noise threshold value (e.g., whether the data noise value is above the noise threshold value).

The target symbol may refer to a symbol used to determine whether interference occurs based on the calculated data noise value. For example, the target symbol may be the last transmitted symbol among the second number of symbols used to calculate the data noise value. The target symbol may vary depending on the second number of symbols used to calculate the data noise value.

The interference detecting circuit 121 may determine that interference has occurred in the target symbol when the data noise value exceeds the noise threshold value. Contrarily, the interference detecting circuit 121 may determine that interference has not occurred in the target symbol when the data noise value is less than or equal to the noise threshold value.

In an embodiment, the interference detecting circuit 121 may compare a data received value with a reception threshold value. The interference detecting circuit 121 may determine whether interference occurs in a target symbol based on a result of comparing the data received value with the reception threshold value.

The interference detecting circuit 121 may determine that interference has occurred in the target symbol when the data received value exceeds the reception threshold value. Contrarily, the interference detecting circuit 121 may determine that interference has not occurred in the target symbol when the data received value is less than or equal to the reception threshold value.

In an embodiment, when it is determined that interference has occurred in a previous symbol before a target symbol and the target symbol is included in the second type block, the interference detecting circuit 121 may determine whether interference occurs in the target symbol based on a result of comparing a data received value with a reception threshold value. Here, the previous symbol may not only refer to a symbol immediately preceding the target symbol but may refer to any one of the symbols included in a block including the target symbol and the symbols included in a block immediately preceding the block including the target symbol.

In the case where interference occurs in a previous symbol before a target symbol, the accuracy of a channel estimation value (h in Equations 1, 2, 6, and 7) may decrease. Accordingly, when it is determined whether interference occurs in the target symbol based on a result of comparing a noise threshold value with a data noise value calculated using the channel estimation value, the accuracy of interference detection may also decrease. At this time, when the target symbol is included in the second type block, the training sequence agreed between the wireless communication device 100 and an external device is transmitted to the interference detecting circuit 121. Accordingly, when it is determined whether interference occurs in the target symbol based on a result of comparing a data received value with a reception threshold value, the accuracy of interference detection may be maintained high.

Otherwise, when it is determined that interference has not occurred in a previous symbol before a target symbol or the target symbol is included in the first type block, the interference detecting circuit 121 may determine whether interference occurs in the target symbol based on a result of comparing a data noise value with a noise threshold value.

When the wireless communication device 100 described above is used, the interference detection performance of the wireless communication device 100 may be increased by detecting interference in a target symbol by comparing a data noise value with a noise threshold value or comparing a data received value with a reception threshold value, based on whether interference occurs in a previous symbol before the target symbol.

When it is determined that interference has occurred in a target symbol, the interference detecting circuit 121 may adjust a noise threshold value based on a data noise value.

In detail, when it is determined that interference has occurred in a target symbol, the interference detecting circuit 121 may adjust a noise threshold value based on a data noise value and a preset adjustment ratio.

Here, the adjustment ratio may determine the increment of the noise threshold value according to an extent to which the data noise value exceeds the noise threshold value. When the adjustment ratio is too large, the interference false alarm rate may decrease while the probability of failing to detect interference that occurs may increase. Contrarily, when the adjustment ratio is too small, the interference false alarm rate may increase while the probability of failing to detect interference that occurs may decrease. Accordingly, the adjustment ratio may be set to correspond to the interference false alarm rate based on which the noise coefficient described above is set.

The interference detecting circuit 121 may adjust a noise threshold value based on Equation 9.

$${γ}_{n\_re} = ( 1 - w ) \cdot {γ}_{n} + w \cdot {nPwr}_{sum} \qquad [ Equation 9 ]$$

In Equation 9, γ_{n_re} represents an adjusted noise threshold value, w represents an adjustment ratio, γₙ represents a noise threshold value before being adjusted, and nPwrₛᵤₘ is a data noise value of a target symbol in which interference occurs.

The interference detecting circuit 121 may adjust a reception threshold value based on a data received value.

In detail, when it is determined that interference has occurred in a target symbol, the interference detecting circuit 121 may adjust a reception threshold value based on a preset adjustment ratio and a data received value.

The interference detecting circuit 121 may adjust a reception threshold value based on Equation 10.

$${γ}_{y\_re} = ( 1 - w ) \cdot {γ}_{y} + w \cdot {yPwr}_{sum} \qquad [ Equation 10 ]$$

In Equation 10, γ_{y_re} represents an adjusted reception threshold value, w represents an adjustment ratio, γ_{y} represents a reception threshold value before being adjusted, and yPwrₛᵤₘ is a data received value of a target symbol in which interference occurs.

When the wireless communication device 100 described above is used, the interference detection performance of the wireless communication device 100 may be increased by adjusting a reception threshold value and a noise threshold value that is used for subsequent interference detection. For example, when a subsequent signal is received, the adjusted threshold value and/or noise threshold value may be used to process the signal to determine interference in the signal.

Therefore, in an embodiment, the interference detecting circuit 121 may additionally perform a subsequent signal processing operation according to a result of detecting interference in a target symbol.

When it is determined that interference has occurred in a target symbol, the interference detecting circuit 121 may stop a channel estimation operation that uses the target symbol. Because a received value has a large error in the case of a symbol in which interference occurs, a large error may also occur in a channel estimation value when the channel estimation value is obtained based on the symbol. Accordingly, the interference detecting circuit 121 may stop the channel estimation operation using the target symbol in which interference is detected. In other words, the interference detecting circuit 121 may perform channel estimation operation without using the target symbol in which interference is detected.

In addition, when it is determined that interference has occurred in the target symbol, the interference detecting circuit 121 may also stop a carrier frequency offset estimation operation that uses the target symbol. Similar to the channel estimation value, a carrier frequency offset may have a large error when being estimated using a target symbol in which interference is detected. Accordingly, the interference detecting circuit 121 may stop the carrier frequency offset estimation operation using the target symbol in which interference is detected. In other words, the interference detecting circuit 121 may perform carrier frequency offset operation without using the target symbol in which interference is detected.

When it is determined that interference has occurred in the target symbol, the interference detecting circuit 121 may also store the index of the target symbol, a data noise value, and a data received value. When interference is detected, the interference detecting circuit 121 may store the index of the target symbol, the data noise value, and the data received value, which are information related to the interference, and may use the information for a report on interference analysis.

When it is determined that interference has not occurred in a target symbol as a result of comparing a data received value with a reception threshold value, the interference detecting circuit 121 may initialize a channel estimation value and a carrier frequency offset.

In detail, when it is determined that interference has not occurred in a target symbol that is included in the second type block, the interference detecting circuit 121 may initialize a channel estimation value and a carrier frequency offset and may newly calculate the channel estimation value and the carrier frequency offset by using the target symbol, in which interference is not detected and which is included in the second type block. This is because the channel estimation value and the carrier frequency offset may be accurately estimated when a training sequence transmitted through the second type block is used since the training sequence that is transmitted through the second type block is a signal that is agreed between the wireless communication device 100 and an external device.

As described above, the interference detecting circuit 121 may increase interference detection performance, channel estimation performance, and carrier frequency offset estimation performance by performing various kinds of subsequent operations based on a result of determining occurrence or non-occurrence of interference. Accordingly, the overall communication performance of the wireless communication device 100 may be increased.

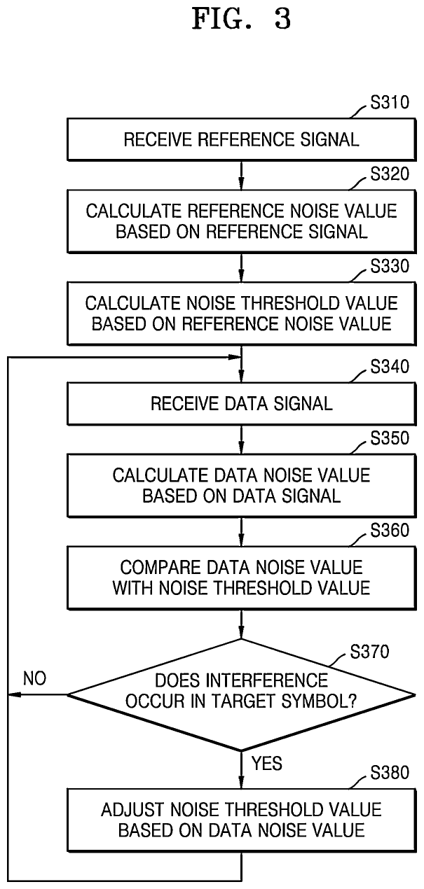

FIG. 3 is a flowchart of an operating method of a wireless communication device, according to an embodiment.

Referring to FIG. 3, a flowchart of a method, by which the wireless communication device 100 determines whether interference occurs in a target symbol based on a reference noise value and a data noise value, is shown.

The wireless communication device 100 may receive a reference signal in operation S310. The wireless communication device 100 may receive the reference signal from another wireless communication device through the transceiver 110.

The wireless communication device 100 may calculate a reference noise value based on the reference signal in operation S320. The wireless communication device 100 may calculate noise through the processor 120 with respect to each of a preset first number of symbols included in the reference signal and may calculate the reference noise value based on the noise with respect to each of the first number of symbols. At this time, the processor 120 may calculate the reference noise value by using Equation 1 or 2.

The wireless communication device 100 may calculate a noise threshold value based on the reference noise value in operation S330. The wireless communication device 100 may set a noise coefficient through the processor 120 based on an interference false alarm rate and may calculate the noise threshold value, based on the noise coefficient and the reference noise value. At this time, the processor 120 may calculate the noise threshold value by using Equation 4.

The wireless communication device 100 may receive a data signal in operation S340. The wireless communication device 100 may receive the data signal from another wireless communication device through the transceiver 110.

The wireless communication device 100 may calculate a data noise value based on the data signal in operation S350. The wireless communication device 100 may calculate noise through the processor 120 with respect to each of a preset second number of symbols included in the data signal and may calculate the data noise value based on the noise with respect to each of the second number of symbols. The processor 120 may calculate the data noise value by using Equation 6 or 7.

The wireless communication device 100 may compare the data noise value with the noise threshold value in operation S350. The wireless communication device 100 may determine through the processor 120 whether the data noise value exceeds the noise threshold value.

The wireless communication device 100 may determine whether interference occurs in a target symbol in operation S370.

When it is determined through the processor 120 that the data noise value exceeds the noise threshold value in operation S360, the wireless communication device 100 may determine that interference has occurred in the target symbol.

Otherwise, when it is determined through the processor 120 that the data noise value is less than or equal to the noise threshold value in operation S360, the wireless communication device 100 may determine that interference has not occurred in the target symbol.

When it is determined that interference has occurred in the target symbol, the method may proceed to operation S380, in which the wireless communication device 100 may adjust the noise threshold value based on the data noise value. Subsequently, in step S380, a new data signal may be received, and interference in the new data signal can be determined according to the steps S340, S350, S360, and S370 using the adjusted noise threshold value and reception threshold value. The wireless communication device 100 may adjust the noise threshold value through the processor 120, based on an adjustment ratio and the data noise value. For example, the processor 120 may adjust the noise threshold value by using Equation 9.

Otherwise, when it is determined that interference has not occurred in the target symbol, the method proceeds to operation S340, in which the wireless communication device 100 may receive a subsequent symbol in the data signal as the target symbol and may newly perform operations S350 to S370.

As described above, when the operating method of the wireless communication device 100 of the inventive concept is used, the interference detection performance of the wireless communication device 100 may be increased by adjusting the noise threshold value, which is used in subsequent interference detection, when it is determined that interference has occurred in the target symbol.

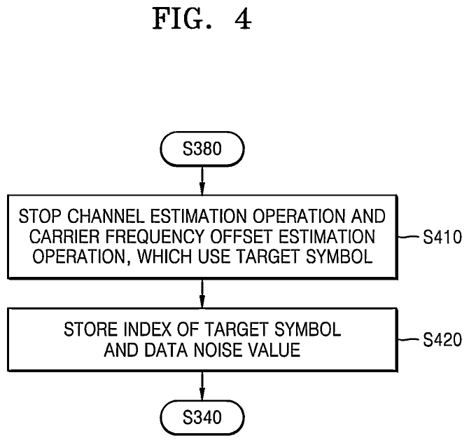

FIG. 4 is a flowchart of subsequent operations that may be performed when interference occurs in a target symbol in an operating method of a wireless communication device, according to an embodiment.

Referring to FIG. 4, a flowchart shows additional operations, which may be performed by the wireless communication device 100 when it is determined that interference has occurred in the target symbol in operation S370. Although it is illustrated in FIG. 4 that the additional operations are performed after operation S380, the additional operations may be performed before operation S380.

The wireless communication device 100 may stop a channel estimation operation and a carrier frequency offset estimation operation, which use the target symbol, in operation S410. The wireless communication device 100 may stop the channel estimation operation and the carrier frequency offset estimation operation, which use the target symbol, through the processor 120 and thus calculate neither a channel estimation value nor a carrier frequency offset based on the target symbol.

The wireless communication device 100 may store an index of the target symbol and the data noise value in operation S420. The wireless communication device 100 may store the index of the target symbol and the data noise value, which are information related to the interference, in an internal memory (not shown) through the processor 120.

When the operating method of the wireless communication device 100 of the inventive concept is used as described above, the overall communication performance of the wireless communication device 100 may be increased by performing additional operations according to interference.

FIG. 5 illustrates an example of a reference signal and a data signal, which are received by a wireless communication device, according to an embodiment.

Referring to FIG. 5, a plurality of blocks, which are included in a reference signal and a data signal, are shown. The blocks may be sequentially transmitted from the left in the diagram.

The reference signal may include a long training sequence (LTS) block and an access address (AA) block. The LTS block and the AA block may include a signal agreed in advance.

The data signal may include a plurality of physical (PHY) blocks and a plurality of per-block training sequence (PBTS) blocks. A PHY block may correspond to a first type block including data to be transmitted by an external device and a PBTS block may correspond to a second type block including a training sequence that is agreed between the external device and the wireless communication device.

The PHY blocks and the PBTS blocks may be alternately received. In the embodiment of FIG. 5, a first PHY block, a first PBTS block, a second PHY block, a second PBTS block, and a third PHY block may be sequentially received.

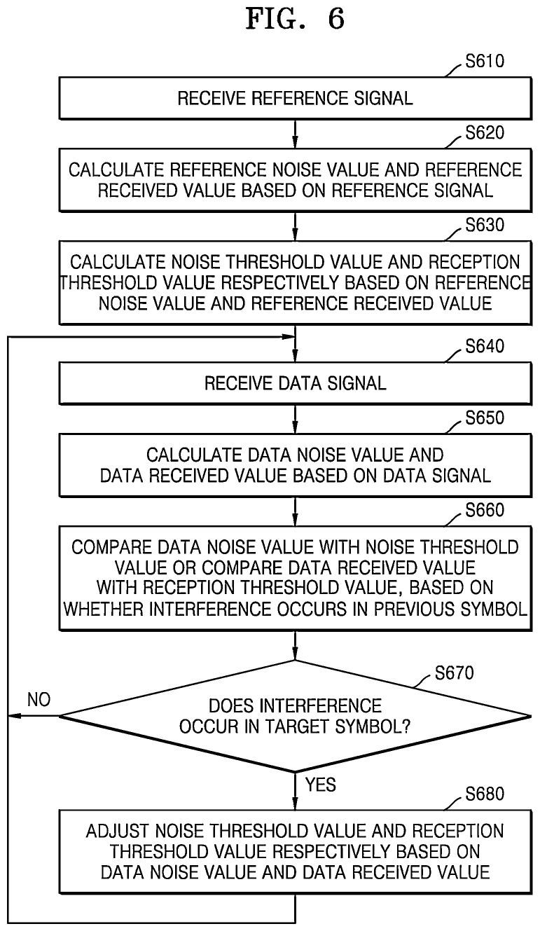

FIG. 6 is a flowchart of an operating method of a wireless communication device, according to some embodiments.

FIG. 6, shows a flowchart of a method of determining whether interference occurs in a target symbol, based on a reference noise value, a reference received value, a data noise value, and a data received value, when a data signal received by the wireless communication device 100 includes a first type block and a second type block.

The wireless communication device 100 receives a reference signal in operation S610. Operation S610 in FIG. 6 may be the same as operation S310 in FIG. 3.

The wireless communication device 100 calculates a reference noise value and a reference received value, based on the reference signal, in operation S620. Compared to operation S320 in FIG. 3, the reference received value may be further calculated in operation S620 in FIG. 6. Accordingly, a method of calculating the reference noise value in operation S620 in FIG. 6 may be the same as the method of calculating the reference noise value in operation S320 in FIG. 3.

The wireless communication device 100 may calculate the reference received value through the processor 120 based on a received value of each of a preset first number of symbols included in the reference signal. For example, the processor 120 may calculate the reference received value by using Equation 3.

The wireless communication device 100 calculates a noise threshold value and a reception threshold value respectively based on the reference noise value and the reference received value in operation S630. Compared to operation S330 in FIG. 3, the reception threshold value may be further calculated in operation S630 in FIG. 6. Accordingly, a method of calculating a noise threshold value in operation S630 in FIG. 6 may be the same as the method of calculating a noise threshold value in operation S330 in FIG. 3.

The wireless communication device 100 may set a reception coefficient through the processor 120 based on an interference false alarm rate and may calculate the reception threshold value, based on the reception coefficient and the reference received value. For example, the processor 120 may calculate the reception threshold value by using Equation 5.

The wireless communication device 100 receives a data signal in operation S640. Operation S640 in FIG. 6 may be the same as operation S340 in FIG. 3.

The wireless communication device 100 calculates a data noise value and a data received value based on the data signal in operation S650. Compared to operation S350 in FIG. 3, the data received value may be further calculated in operation S650 in FIG. 6. Accordingly, a method of calculating a data noise value in operation S650 in FIG. 6 may be the same as the method of calculating a data noise value in operation S350 in FIG. 3.

The wireless communication device 100 may calculate the data received value through the processor 120 based on the received value of each of a preset second number of symbols included in the data signal. For example, the processor 120 may calculate the data received value by using Equation 8.

The wireless communication device 100 compares the data noise value with the noise threshold value or compares the data received value with the reception threshold value, based on whether interference occurs in a previous symbol, in operation S660.

When interference does not occur in the previous symbol, the wireless communication device 100 may compare the data noise value with the noise threshold value through the processor 120. At this time, the processor 120 may determine whether the data noise value exceeds the noise threshold value.

Otherwise, when interference occurs in the previous symbol, the wireless communication device 100 may compare the data received value with the reception threshold value through the processor 120. For example, the processor 120 may determine whether the data received value exceeds the reception threshold value.

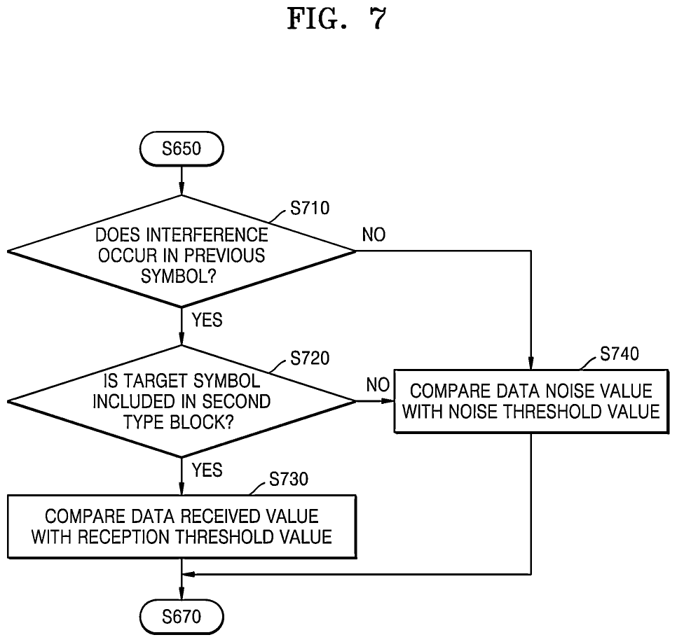

At this time, the wireless communication device 100 may compare the data noise value with the noise threshold value or compare the data received value with the reception threshold value, additionally taking into account the type of block in which a target symbol is included, which is described in detail with reference to FIG. 7 below.

The wireless communication device 100 determines whether interference occurs in the target symbol in operation S670.

When it is determined through the processor 120 that the data noise value exceeds the noise threshold value or the data received value exceeds the reception threshold value in operation S660, the wireless communication device 100 may determine that interference has occurred in the target symbol.

Otherwise, when it is determined through the processor 120 that the data noise value is less than or equal to the noise threshold value or the data received value is less than or equal to the reception threshold value in operation S660, the wireless communication device 100 may determine that interference has not occurred in the target symbol.

When it is determined that interference has occurred in the target symbol, the method may proceed to operation S680, in which the wireless communication device 100 adjusts the noise threshold value and the reception threshold value respectively based on the data noise value and the data received value. Subsequently, in step S640, a new data signal may be received, and interference in the new data signal can be determined according to the steps S650, S660, S670, and S680 using the adjusted noise threshold value and reception threshold value. Compared to operation S380 in FIG. 3, the reception threshold value may be further calculated in operation S680 in FIG. 6. Accordingly, a method of adjusting a noise threshold value in operation S680 in FIG. 6 may be the same as the method of adjusting a noise threshold value in operation S380 in FIG. 3.

The wireless communication device 100 may adjust the reception threshold value through the processor 120, based on an adjustment ratio and the data received value. For example, the processor 120 may adjust the reception threshold value by using Equation 10.

Otherwise, when it is determined that interference has not occurred in the target symbol, the method proceeds to operation S640, in which the wireless communication device 100 may receive a subsequent symbol in the data signal as the target symbol and may newly perform operations S650 to S670.

FIG. 7 is a detailed flowchart of operation S660 in FIG. 6.

Referring to FIG. 7, the wireless communication device 100 determines whether interference occurs in a previous symbol before a target symbol in operation S710. The wireless communication device 100 may determine through the processor 120 whether interference occurs in symbols, which are included in a block including the target symbol, and symbols, which are included in a block immediately before the block including the target symbol.

When it is determined that interference has not occurred in the previous symbol before the target symbol, the method proceeds to operation S740, in which the wireless communication device 100 compares the data noise value with the noise threshold value.

Otherwise, when it is determined that interference has occurred in the previous symbol before the target symbol, the method proceeds to operation S720, in which the wireless communication device 100 may determine whether the target symbol is included in a second type block. The wireless communication device 100 may determine through the processor 120 whether the target symbol is included in the second type block, thereby determining whether the target symbol corresponds to a training sequence.

When it is determined that the target symbol is not included in the second type block, the method proceeds to operation S740, in which the wireless communication device 100 compares the data noise value with the noise threshold value.

Otherwise, when it is determined that the target symbol is included in the second type block, the method proceeds to operation S730, in which the wireless communication device 100 compares the data received value with the reception threshold value.

As described above, when the operating method of the wireless communication device 100 according to aspects of the inventive concept is used, the interference detection performance of the wireless communication device 100 may be increased by comparing a data noise value with a noise threshold value or comparing a data received value with a reception threshold value, based on whether interference occurs in a previous symbol before a target symbol and whether the target symbol is included in a second type block.

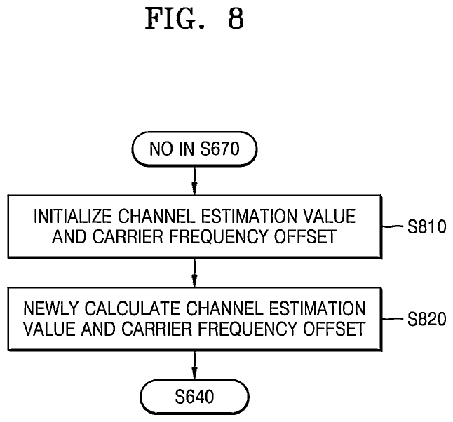

FIG. 8 is a flowchart of operations that may be performed when interference is not detected in an operating method of a wireless communication device, according to an embodiment.

FIG. 8 shows a flowchart showing operations, which may be performed by the wireless communication device 100 when it is determined that interference has not occurred, based on a result of comparing the data received value with the reception threshold value in operation S670.

The wireless communication device 100 may initialize a channel estimation value and a carrier frequency offset in operation S810. Since interference occurs in the previous symbol, the wireless communication device 100 may determine whether interference occurs in the target symbol by comparing the data received value with the reception threshold value. Accordingly, when it is determined through the processor 120 that the interference has not occurred in the target symbol, the wireless communication device 100 may determine that there is no further interference and may initialize the channel estimation value and the carrier frequency offset for more accurate measurement of the channel estimation value and the carrier frequency offset.

The wireless communication device 100 may newly calculate the channel estimation value and the carrier frequency offset in operation S820. The wireless communication device 100 may more accurately calculate the channel estimation value and the carrier frequency offset by using the target symbol, in which interference is not detected by the processor 120 and which is included in the second type block.

According to some embodiments, when the operating method of the wireless communication device 100 of the inventive concept described above is used, the overall communication performance of the wireless communication device 100 may be increased by newly calculating a channel estimation value and a carrier frequency offset when interference occurs in a previous symbol but not in a target symbol.

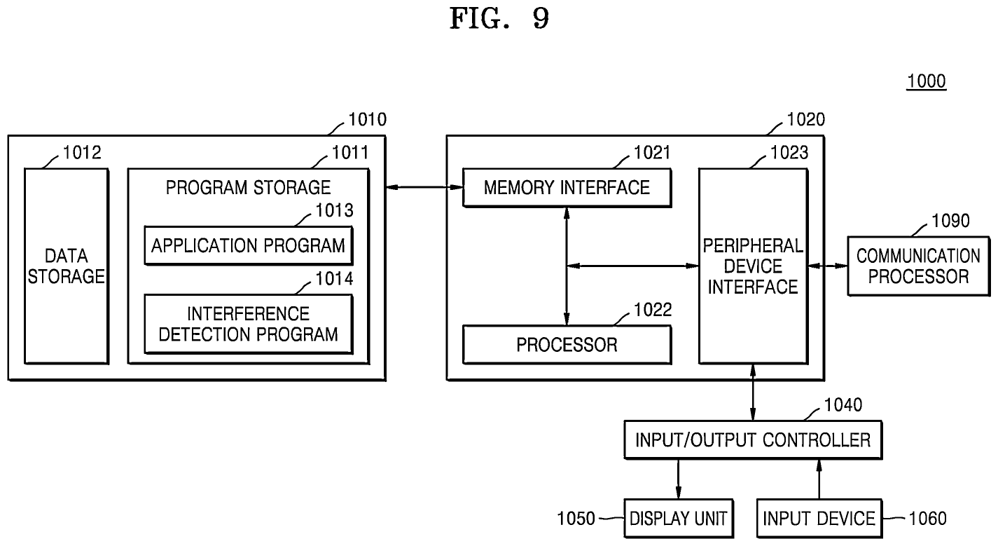

FIG. 9 is a schematic block diagram of an electronic device 1000 according to an embodiment.

Referring to FIG. 9, the electronic device 1000 may include a memory 1010, a processor unit 1020, an input/output controller 1040, a display unit 1050, an input device 1060, and a communication processor 1090. There may be a plurality of memories 1010. Each element will be described below.

The memory 1010 may include a program storage 1011, which stores a program for controlling an operation of the electronic device 1000, and a data storage 1012, which stores data generated during execution of the program. The data storage 1012 may store data necessary for the operation of an application program 1013 and the operation of an interference detection program 1014 or data generated from the operations of the application program 1013 and the interference detection program 1014.

The program storage 1011 may include the application program 1013 and the interference detection program 1014. At this time, a program included in the program storage 1011 may be a set of instructions and expressed as an instruction set. The application program 1013 may include program code for executing various applications run by the electronic device 1000. In other words, the application program 1013 may include code (or commands) related to various applications run by a processor 1022.

According to embodiments, the interference detection program 1014 may calculate a reference noise value based on a reference signal, calculate a noise threshold value based on the reference noise value, calculate a data noise value based on a data signal, compare the data noise value with the noise threshold value, and determine whether interference occurs in a target symbol. When it is determined that interference has occurred in the target symbol, the interference detection program 1014 may adjust the noise threshold value based on the data noise value.

The communication processor 1090 of the electronic device 1000 may perform communication functions for voice communication and data communication. A peripheral device interface 1023 may control connection among the input/output controller 1040, the communication processor 1090, the processor 1022, and a memory interface 1021. The processor 1022 may control a plurality of base stations to provide a service using at least one software program. At this time, the processor 1022 may execute at least one program stored in the memory 1010 to provide a service corresponding to the program.

The input/output controller 1040 may provide an interface between an input/output device, such as the display unit 1050 or the input device 1060, and the peripheral device interface 1023. The display unit 1050 displays status information, input text, a moving picture, and/or a still picture. For example, the display unit 1050 may display information about an application program run by the processor 1022.

The input device 1060 may provide input data, which is generated by the selection of the electronic device 1000, to the processor unit 1020 through the input/output controller 1040. At this time, the input device 1060 may include a keypad, which includes at least one hardware button, and/or a touch pad sensing touch information. For example, the input device 1060 may provide touch information, such as a touch, movement of the touch, or the release of the touch, which is detected through a touch pad, to the processor 1022 through the input/output controller 1040.

While the inventive concept has been particularly shown and described with reference to embodiments thereof, it will be understood that various changes in form and details may be made therein without departing from the spirit and scope of the following claims.

What is claimed is:

1. An operating method of a wireless communication device, the operating method comprising:
receiving at a receiver of a first wireless device a reference signal transmitted from a second wireless device;
calculating, by a processor of the first wireless device, a reference noise value based on the reference signal;
calculating, by the processor, a noise threshold value based on the reference noise value;
receiving at the receiver of the first wireless device a first data signal transmitted from the second wireless device;
calculating, by the processor, a data noise value based on the first data signal;
comparing, by the processor, the data noise value with the noise threshold value;
determining, by the processor, whether interference occurs in a target symbol based on a result of the comparison;
adjusting, by the processor, the noise threshold value based on the data noise value when it is determined that the interference has occurred in the target symbol; and
receiving at the receiver of the first wireless device a second data signal transmitted from the second wireless device, and using the adjusted noise threshold value in processing the second data signal.

2. The operating method of claim 1, wherein:
the calculating of the reference noise value includes:
calculating noise with respect to each of a preset first number of symbols included in the reference signal; and
calculating the reference noise value based on the noise with respect to each of the preset first number of symbols.

3. The operating method of claim 1, wherein:
the calculating of the noise threshold value includes:
setting a noise coefficient based on an interference false alarm rate; and
calculating the noise threshold value, based on the reference noise value and the noise coefficient.

4. The operating method of claim 1, wherein:
the calculating of the data noise value includes:
calculating noise with respect to each of a preset second number of symbols corresponding to the first data signal; and
calculating the data noise value based on the noise with respect to each of the preset second number of symbols.

5. The operating method of claim 1, wherein:
the determining of whether the interference occurs in the target symbol includes:
determining that the interference has occurred in the target symbol when the data noise value exceeds the noise threshold value; and
determining that the interference has not occurred in the target symbol when the data noise value is less than or equal to the noise threshold value.

6. The operating method of claim 1, wherein the adjusting of the noise threshold value includes adjusting the noise threshold value, based on a preset adjustment ratio and the data noise value.

7. The operating method of claim 1, further comprising:
stopping a channel estimation operation and a carrier frequency offset estimation operation, which use the target symbol, when it is determined that the interference has occurred in the target symbol.

8. The operating method of claim 1, further comprising storing an index of the target symbol and the data noise value when it is determined that the interference has occurred in the target symbol.

9. An operating method of a wireless communication device, the operating method comprising:
receiving at a receiver of a first wireless device a reference signal transmitted from a second wireless device;
calculating, by a processor of the first wireless device, a reference noise value and a reference received value based on the reference signal;
calculating, by the processor, a noise threshold value and a reception threshold value respectively based on the reference noise value and the reference received value;
receiving at the receiver of the first wireless device a first data signal transmitted from the second wireless device, the first data signal including a first type block and a second type block;
calculating, by the processor, a data noise value and a data received value based on the first data signal;
based on whether interference occurs in a previous symbol before a target symbol, either comparing, by the processor, the data noise value with the noise threshold value, or comparing, by the processor, the data received value with the reception threshold value;
determining, by the processor, whether interference occurs in the target symbol based on a result of the comparison;
adjusting, by the processor, the noise threshold value and the reception threshold value respectively based on the data noise value and the data received value when it is determined that the interference has occurred in the target symbol; and
receiving at the receiver of the first wireless device a second data signal transmitted from the second wireless device, and using the adjusted noise threshold value and reception threshold value in processing the second data signal.

10. The operating method of claim 9, wherein:
the calculating of the reference noise value and the reference received value includes:
calculating noise with respect to each of a preset first number of symbols included in the reference signal;
calculating the reference noise value based on the noise with respect to each of the preset first number of symbols; and
calculating the reference received value based on a received value of each of the preset first number of symbols.

11. The operating method of claim 9, wherein:
the calculating of the noise threshold value and the reception threshold value includes:
setting a noise coefficient and a reception coefficient based on an interference false alarm rate;
calculating the noise threshold value, based on the reference noise value and the noise coefficient; and
calculating the reception threshold value, based on the reference noise value and the reception coefficient.

12. The operating method of claim 9, wherein:
the calculating of the data noise value and the data received value includes:
calculating noise with respect to each of a preset second number of symbols corresponding to the first data signal;
calculating the data noise value based on the noise with respect to each of the preset second number of symbols; and
calculating the data received value based on a received value with respect to each of the preset second number of symbols.

13. The operating method of claim 12, wherein the preset second number of symbols are included in the first type block.

14. The operating method of claim 9, wherein:
the comparing of the data noise value with the noise threshold value or the comparing of the data received value with the reception threshold value includes:
comparing the data received value with the reception threshold value when it is determined that the interference has occurred in the previous symbol before the target symbol and when the target symbol is included in the second type block; and
comparing the data noise value with the noise threshold value when it is determined that the interference has not occurred in the previous symbol before the target symbol or when the target symbol is included in the first type block.

15. The operating method of claim 14, wherein:
the determining of whether the interference occurs in the target symbol based on the result of the comparison includes:
determining that the interference has occurred in the target symbol when the data received value exceeds the reception threshold value; and
determining that the interference has not occurred in the target symbol when the data received value is less than or equal to the reception threshold value.

16. The operating method of claim 15, further comprising:
initializing a channel estimation value and a carrier frequency offset when it is determined that the interference has not occurred in the target symbol because the data received value is less than or equal to the reception threshold value; and
newly calculating the channel estimation value and the carrier frequency offset.

17. The operating method of claim 14, wherein:
the determining of whether the interference occurs in the target symbol based on the result of the comparison includes:
determining that the interference has occurred in the target symbol when the data noise value exceeds the noise threshold value; and
determining that the interference has not occurred in the target symbol when the data noise value is less than or equal to the noise threshold value.

18. The operating method of claim 9, wherein:
the adjusting of the noise threshold value and the reception threshold value includes
adjusting the noise threshold value, based on a preset adjustment ratio and the data noise value; and
adjusting the reception threshold value, based on the preset adjustment ratio and the data received value.

19. The operating method of claim 9, further comprising:
stopping a channel estimation operation and a carrier frequency offset estimation operation, which use the target symbol, when it is determined that the interference has occurred in the target symbol.

20. A wireless communication device comprising:
a transceiver configured to receive a reference signal, a first data signal, and a second data signal, from an external device; and
a processor configured to calculate a reference noise value based on the received reference signal, calculate a noise threshold value based on the reference noise value, calculate a data noise value based on the received first data signal, compare the data noise value with the noise threshold value, determine whether interference occurs in a target symbol based on a result of the comparison, adjust the noise threshold value based on the data noise value when it is determined that the interference has occurred in the target symbol, and use the adjusted noise threshold value for processing the received second data signal.
